(19) United States
(12) Patent Application Publication
(10) Pub. No.: US 2022/0035405 A1
(43) Pub. Date: Feb. 3, 2022

(54) PRESSING DEVICE

(71) Applicant: SUNREX TECHNOLOGY CORP., Taichung City (TW)

(72) Inventors: Shih-Pin LIN, Taichung City (TW); Chun-Chieh CHEN, Taichung City (TW); Ling-Cheng TSENG, Taichung City (TW); Yu-Shuo YANG, Taichung City (TW)

(73) Assignee: SUNREX TECHNOLOGY CORP., Taichung City (TW)

(21) Appl. No.: 17/093,851

(22) Filed: Nov. 10, 2020

(30) Foreign Application Priority Data
Aug. 3, 2020 (TW) 109209980

(51) Int. Cl. G06F 1/16; G06F 3/0354

(52) U.S. Cl. CPC G06F 1/169; G06F 3/03547; G06F 1/1622

(57) ABSTRACT

A pressing device includes a base board unit including at least two coupling members, an upper board unit including a trigger switch and at least two engaging members, and two interlocking members disposed between the upper board unit and the base board unit. Each interlocking member has at least one coupling portion coupled with a respective coupling member, at least one engaging portion coupled with a respective engaging member, and at least one locking set. The locking set of one interlocking member is coupled with the locking set of the other interlocking member. When the upper board unit is pressed, the interlocking members are pivoted and the trigger switch is converted from an initial state to a triggered state.

### CROSS-REFERENCE TO RELATED APPLICATION

This application claims priority of Taiwanese Patent Application No. 109209980, filed on Aug. 3, 2020.

### FIELD OF THE INVENTION

The disclosure relates to an electronic device, and more particularly to a touch input device for consumer electronics.

### BACKGROUND OF THE INVENTION

Most of the existing laptops today are equipped with a keyboard and a touch pad or a track pad as the input interface. Particularly, a touch pad includes a touch-sensitive area for a user to move a cursor on the screen, and also depressible keys to function as a left-click, a right-click and a scroll of a mouse.

As shown in FIG. 10, a conventional touch pad disclosed in Taiwanese Patent No. 1659344 includes a base board unit 100, a circuit board 200 and a touch board 300. The base board unit 100 includes a first side portion 110, a plurality of first hook seats 130 formed on the first side portion 110, a plurality of second hook seats 140 formed on the first side portion 110 and disposed at an inner side of the first hook seats 130, a second side portion 160 opposite to the first side portion 110, and a triggering unit 150 disposed on the second side portion 160. The circuit board 200 includes a holder 220 fixed on the base board unit 100, and an elastic switch 270 corresponding to the triggering unit 150. The holder 220 includes a plurality of elastic hooks 240 engaging respectively with the first hook seats 130, and a plurality of limit hooks 260 engaging with the second hook seats 140.

When the side of the circuit board 200 with the elastic switch 270 is pressed, the circuit board 200 pivots relative to the base board unit 100 with the limit hooks 260 serving as a pivot axis, so that the elastic switch 270 is compressed by the triggering unit 150 to generate a corresponding signal.

However, when the side of the circuit board 200 which is adjacent to the holder 220 is pressed, the circuit board 200 will be unable to pivot relative to the base board 100.

### SUMMARY OF THE INVENTION

Therefore, an object of the disclosure is to provide a pressing device for touch pads that can alleviate at least one of the drawbacks of the prior art.

According to the disclosure, the pressing device includes a base board unit, an upper board unit and a pair of interlocking members.

The base board unit includes at least two coupling members. The upper board unit is disposed over the base board unit, and includes a panel, a circuit board that is connected to and disposed under the panel, a trigger switch that is connected to and disposed under the circuit board, and at least two engaging members that are connected to and disposed under the circuit board. The engaging members are respectively disposed on the opposite sides of the trigger switch.

The pair of interlocking members is disposed between the base board unit and the upper board unit. Each interlocking member has at least one coupling portion that is coupled with a respective one of the at least two coupling members, and at least one engaging portion that is coupled with a respective one of the at least two engaging members. Each interlocking member further has at least one locking set that is disposed on a side of the at least one coupling portion opposite to the at least one engaging portion. The at least one locking set of one of the interlocking members is coupled with the at least one locking set on the other one of the interlocking members.

When the upper board unit is pressed toward the base board unit, the interlocking members are pivoted relative to each other and the trigger switch is converted from an initial state to a triggered state.

### BRIEF DESCRIPTION OF THE DRAWINGS

Other features and advantages of the disclosure will become apparent in the following detailed description of the embodiment(s) with reference to the accompanying drawings, of which:

FIG. 1 is an exploded perspective view illustrating an embodiment of the pressing device according to the present disclosure.

FIG. 2 is an exploded perspective view of two interlocking members of the embodiment.

FIG. 3 is an enlarged fragmentary exploded perspective view of the interlocking members of the embodiment.

FIG. 4 is an assembled perspective view of the interlocking members of the embodiment;

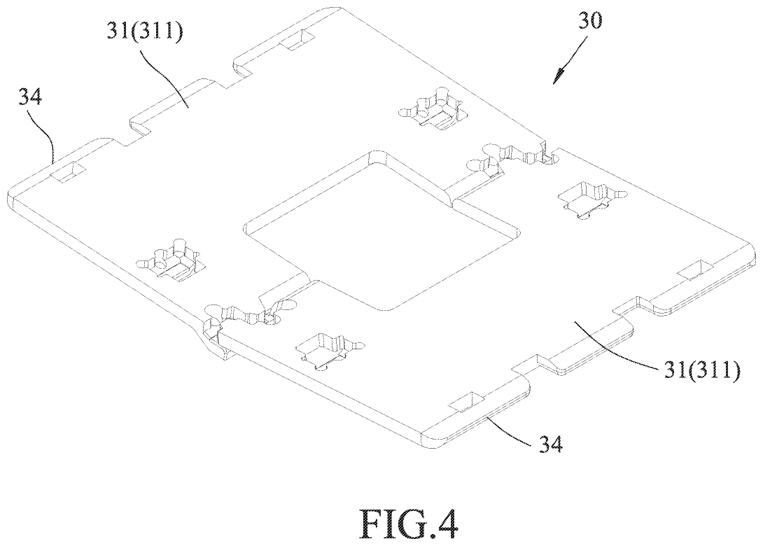

FIG. 5 is a top view of the embodiment, illustrating a trigger switch at an initial state.

FIG. 6 is a sectional view of the embodiment taken along line VI-VI in FIG. 5.

FIG. 7 is a sectional view of the embodiment taken along line VII-VII in FIG. 5.

FIG. 8 is a sectional view of the embodiment illustrating the trigger switch at a triggered state;

FIG. 9 is a view similar to FIG. 6, but illustrating the trigger switch at the triggered state; and

FIG. 10 is an exploded perspective view of a conventional touch pad device.

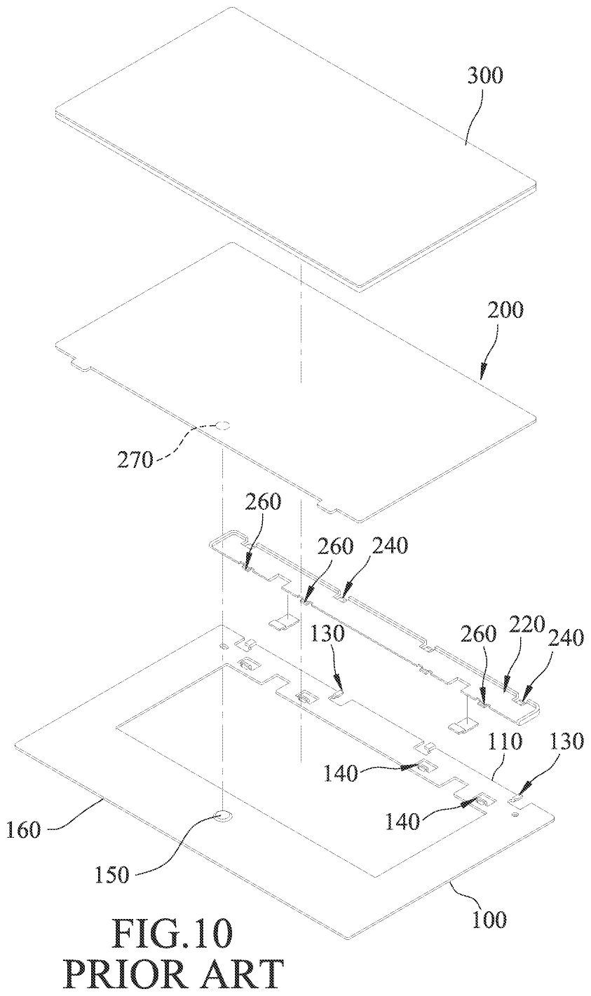

### DETAILED DESCRIPTION

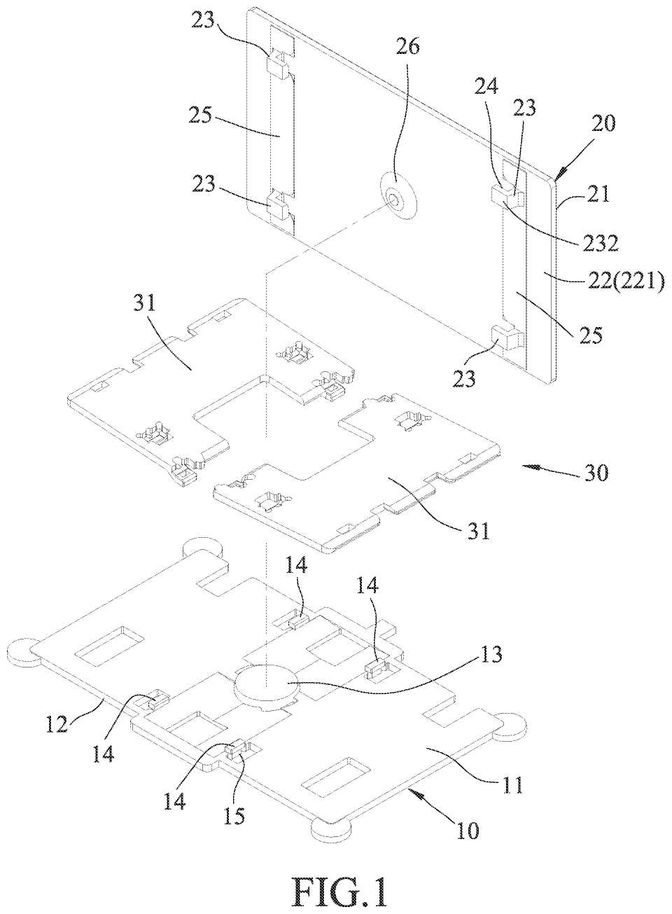

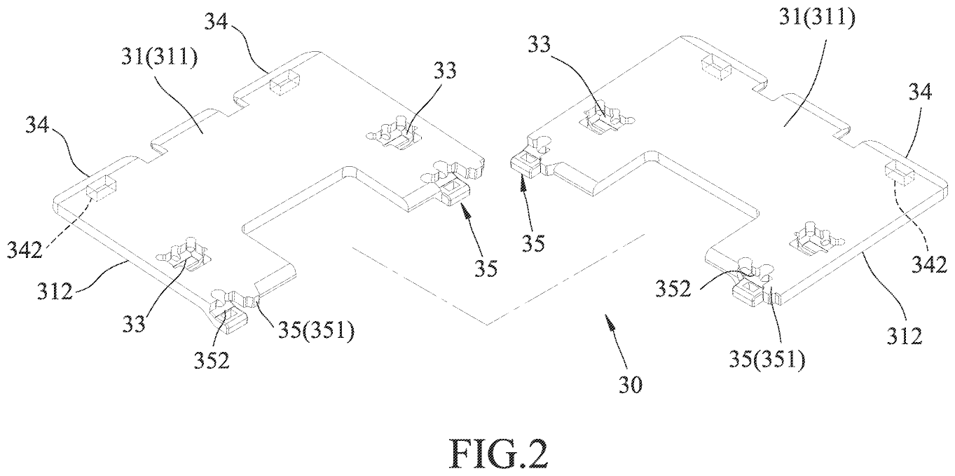

Referring to FIGS. 1 to 3, an embodiment of a pressing device according to the disclosure includes a base board unit 10, an upper board unit 20, and an interlocking unit 30.

The base board unit 10 includes an upper end surface 11, a lower end surface 12 that is opposite to the upper end surface 11, a triggering portion 13, and two pairs of coupling members 14. Each of the coupling members 14 extends upwardly from the upper end surface 11 to be inverted-L-shaped, and cooperates with the upper end surface 11 to define a coupling groove 15 therebetween.

The upper board unit 20 is disposed over the base board unit 10, and includes a panel 21, a circuit board 22 connected to and disposed under the panel 21 and having a lower flat surface 221, a trigger switch 26 connected to and disposed under the lower flat surface 221 of the circuit board 22, and two pairs of engaging members 23 connected to and disposed under the lower flat surface 221 of the circuit board 22. The trigger switch 26 uses metal spring units for providing elasticity that allows the trigger switch 26 to resume to its original state after deformation caused by a pressure exerted thereon. In this embodiment, the two pairs of the engaging members 23 are respectively disposed on opposite sides of the trigger switch 26.

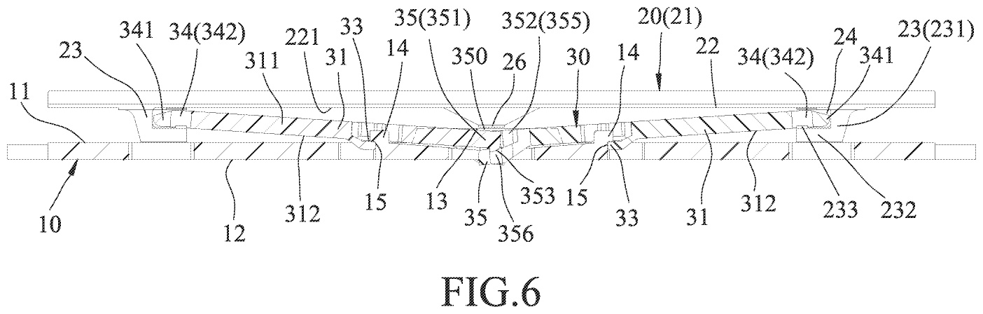

Referring to FIG. 6, each of the engaging members 23 is substantially L-shaped, and has a connecting portion 231 extending downwardly from the lower flat surface 221 of the upper board unit 20, and a guiding portion 232 extending transversely from the connecting portion 231 and cooperating with the lower flat surface 221 and the connecting portion 231 to define an engaging groove 24. Referring back to FIG. 1, the upper board unit 20 further includes a pair of brackets 25 that are disposed on the lower flat surface 221 of the circuit board 22. Each pair of the engaging members 23 is connected to a respective one of the brackets 25.

Referring to FIGS. 1 to 3 and 6, the interlocking unit 30 includes two interlocking members 31 that are disposed between the base board unit 10 and the upper board unit 20. In this embodiment, each of the interlocking members 31 has a top surface 311 facing the upper board unit 20, a bottom surface 312 facing the base board unit 10, two coupling portions 33 coupled respectively with the coupling members 14 of a corresponding pair, two engaging portions 34 coupled respectively with the engaging members 23 of a corresponding pair, and two locking sets 35 disposed on a side of the coupling portions 33 which is opposite to the engaging portions 34. Each of the locking sets 35 has a locking body 351 and a locking groove 352 indented from the top surface 311. The two locking sets 35 of one of the interlocking members 31 are coupled respectively with the two locking sets 35 of the other one of the interlocking members 31. Specifically, the locking body 351 of each locking set 35 of one of the interlocking members 31 pivotally engages the locking groove 352 of the respective locking set 35 of the other one of the interlocking members 31.

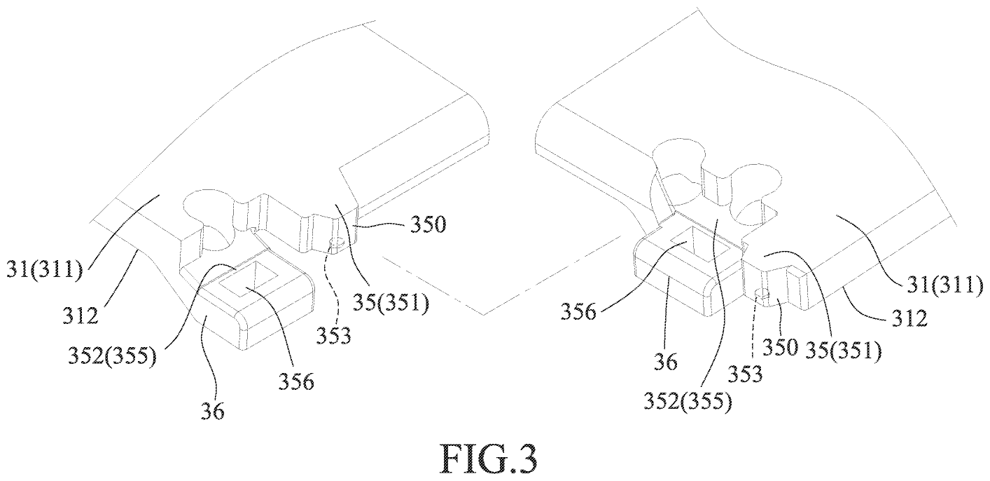

As shown in FIG. 3, for each interlocking member 31, the locking body 351 of each locking set 35 has a main portion 350 and a locking portion 353 protruding downwardly from the main portion 350, and the locking groove 352 of each locking set 35 has a wide portion 355 and a narrow portion 356 that is smaller than the wide portion 355. As shown in FIG. 6, the main portion 350 and the locking portion 353 of the locking body 351 of each locking set 35 of one of the interlocking members 31 respectively engage with the wide portion 355 and the narrow portion 356 of the locking groove 352 of the respective locking set 35 of the other one of the interlocking members 31.

Each of the interlocking members 31 further has a locking wall portion 36 extending from the bottom surface 312 and being slightly L-shaped. In this embodiment, the wide portion 355 of the locking groove 352 of each locking set 35 of each interlocking member 31 extends from the top surface 311 of the interlocking member 31 through the bottom surface 312 of the interlocking member 31 to the locking wall portion 36 of the interlocking member 31, while the narrow portion 356 of the locking groove 352 of each locking set 35 of each interlocking member 31 is formed in the locking wall portion 36 of the interlocking member 31.

Referring to FIG. 6, each coupling portion 33 of each interlocking member 31 extends downwardly from the bottom surface 312 of the interlocking member 31 to be L-shaped. Each of the engaging portions 34 of each interlocking member 31 has an engaging body 341 that is disposed to be engaged with the engaging groove 24 of a respective one of the engaging members 23 of the upper board unit 20, and an engaging hole 342 that is formed in the engaging body 341. The guiding portion 232 of each of the engaging members 23 of the upper board unit 20 has a protrusion 233 protruding into the engaging hole 342 of a respective one of the engaging portions 34 of the interlocking members 31. Each coupling groove 15 of the base board unit 10 is engaged with a respective one of the coupling portions 33 of the interlocking members 31.

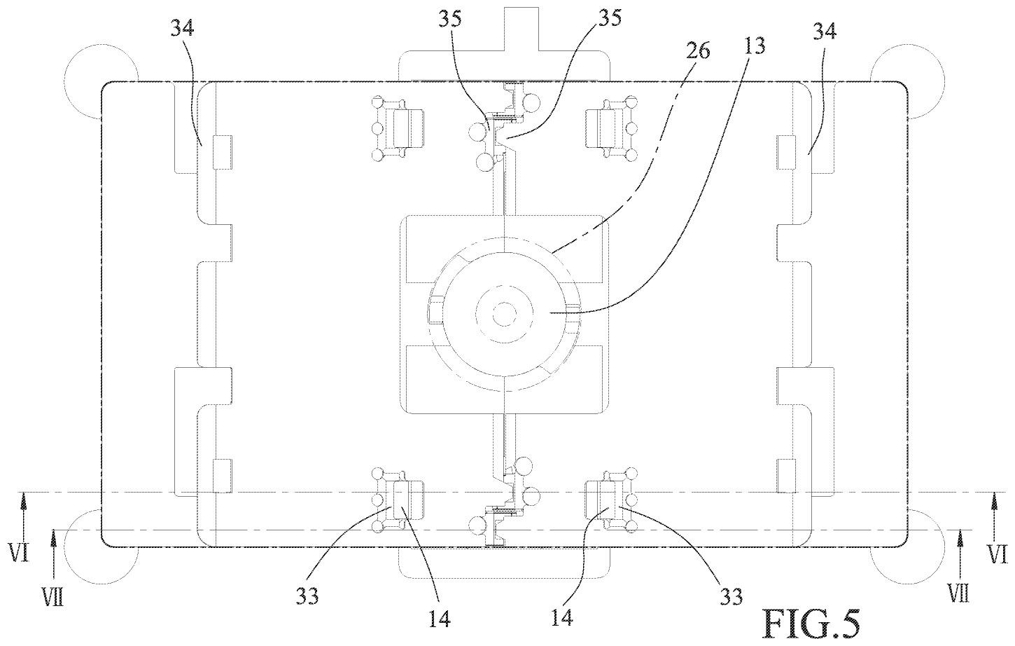

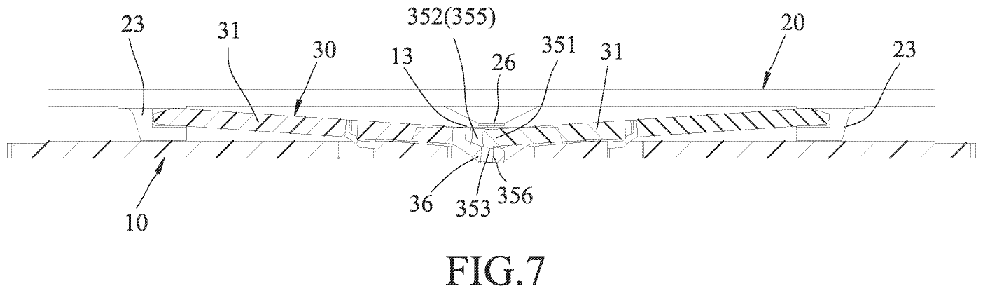

Referring to FIGS. 5 to 7, before the pressing device is operated, the trigger switch 26 is at an initial state, where the trigger switch 26 is in contact with the triggering portion 13 of the base board unit 10, and is not compressed by the triggering portion 13. At this moment, no signal is generated as the trigger switch 26 has not been triggered by the triggering portion 13.

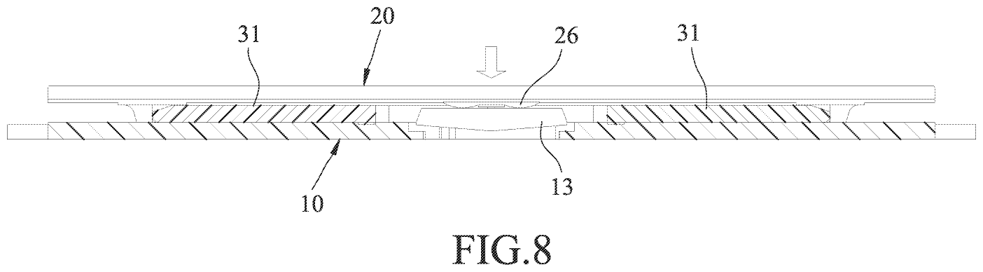

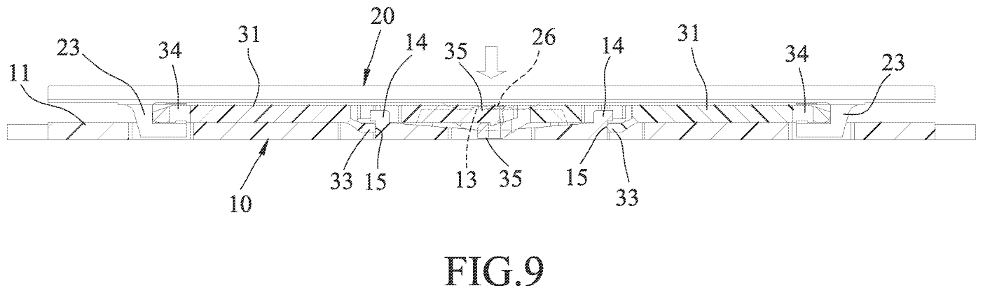

Referring to FIG. 8 and FIG. 9, when the upper board unit 20 is pressed toward the base board unit 10, the interlocking members 31 are pivoted relative to each other. Specifically, each interlocking member 31 is pivoted with the corresponding coupling members 14 (see FIG. 1) serving as the pivot. Consequently, by virtue of the engagement between the locking sets 35 of the interlocking members 31, the locking sets 35 of the interlocking members 31 are pivoted upwardly toward the upper board unit 20, and the engaging portions 34 of the interlocking members 31 are simultaneously moved downwardly. At this moment, each of the interlocking members 31 slides slightly toward an inner side of the corresponding pair of the engaging members 23. As a result, when the upper board unit 20 is pressed downward, the trigger switch 26 deforms as it receives pressure from the triggering portion 13 to convert from the initial state to a triggered state and generate signals. Generation of the signal is realized by virtue of the trigger switch 26 and the circuit board 22 as are commonly known in the art, so details of the same are omitted herein for the sake of brevity.

The configuration that the interlocking members 31 are disposed between the base board unit 10 and the upper board unit 20 offers technical advantages. When pressing any position on the top surface of the upper board unit 20, the upper board unit 20 can move steadily and downwardly via the engagement between the locking sets 35 of the interlocking members 31 thereby effectively converting the trigger switch 26 from the initial state to the triggered state. During operation, the upper board unit 20 will not be tilted from one side, so reliability and effectiveness of operation can be achieved for the pressing device.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A pressing device for a touchpad, comprising:
a base board unit including at least two coupling members;
an upper board unit disposed over said base board unit and including
a panel,
a circuit board that is connected to and disposed under said panel,
a trigger switch that is connected to and disposed under said circuit board, and
at least two engaging members that are connected to and disposed under said circuit board, and that are respectively disposed on opposite sides of said trigger switch; and
a pair of interlocking members disposed between said base board unit and said upper board unit, each of said interlocking members having
at least one coupling portion that is coupled with a respective one of said at least two coupling members,
at least one engaging portion that is coupled with a respective one of said at least two engaging members, and
at least one locking set that is disposed on a side of said at least one coupling portion opposite to said at least one engaging portion;
wherein said at least one locking set of one of said interlocking members is coupled with said at least one locking set of the other one of said interlocking members; and
wherein when said upper board unit is pressed toward said base board unit, said interlocking members are pivoted relative to each other and said trigger switch is converted from an initial state to a triggered state.

2. The pressing device as claimed in claim 1, wherein:
each of said interlocking members further has a top surface facing said upper board unit and a bottom surface opposite to said top surface and facing said base board unit;
said at least one locking set of each of said interlocking members has a locking body, and a locking groove indented from said top surface; and
said locking body of said at least one locking set of one of said interlocking members pivotably engages said locking groove of said at least one locking set of the other one of said interlocking members.

3. The pressing device as claimed in claim 2, wherein:
said locking body of said at least one locking set of each of said interlocking members has a main portion and a locking portion protruding downwardly from said main portion;
said locking groove of said at least one locking set of each of said interlocking members has a wide portion and a narrow portion smaller than said wide portion; and
said main portion and said locking portion of said locking body of said at least one locking set of one of said interlocking members respectively engage with said wide portion and said narrow portion of said locking groove of said at least one locking set of the other one of said interlocking members.

4. The pressing device as claimed in claim 3, wherein each of said interlocking members further has a locking wall portion extending from said bottom surface and being slightly L-shaped, said wide portion of said locking groove of said at least one locking set of each of said interlocking members extending from said top surface of said interlocking member through said bottom surface to said locking wall portion of said interlocking member, said narrow portion of said locking groove of said at least one locking set of each of said interlocking members being formed in said locking wall portion of said interlocking member.

5. The pressing device as claimed in claim 2, wherein:
said at least one coupling portion of each of said interlocking members extends downwardly from said bottom surface of said interlocking member to be L-shaped;
said base board unit has an upper end surface;
each of said at least two coupling members extends upwardly from said upper end surface to be inverted-L-shaped, and cooperates with said upper end surface to define a coupling groove that is engaged with said at least one coupling portion of the respective one of said interlocking members.

6. The pressing device as claimed in claim 1, wherein:
said at least one engaging end portion of each of said interlocking members has an engaging body, and an engaging hole formed in said engaging body;
said upper board unit has a lower flat surface;
each of said at least two engaging members is substantially L-shaped, and has a connecting portion that extends downwardly from said lower flat surface, and
a guiding portion that extends transversely from said connecting portion, that cooperates with said lower flat surface and said connecting portion to define an engaging groove engaged with said engaging body of said at least one engaging end portion of the respective one of said interlocking members, and that has a protrusion protruding into said engaging hole of said at least one engaging end portion of the respective one of said interlocking members.
